(19) United States
(12) Patent Application Publication
(10) Pub. No.: US 2007/0139158 A1
(43) Pub. Date: Jun. 21, 2007

(54) RF PROTOCOL WITH VARIABLE PERIOD WAKEUP

(75) Inventors: Neal Richard Manson, Southfield, MI (US); Ronald O. King, Brownstone, MI (US); Thomas J. LeMense, Farmington, MI (US); Riad Ghabra, Dearborn Hts., MI (US); Jason Summerford, Novi, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 11/306,281

(22) Filed: Dec. 21, 2005

(51) Int. Cl. G05B 19/00

(52) U.S. Cl. 340/5.64; 307/10.1; 455/343.2; 340/5.72; 340/539.3

(57) ABSTRACT

A remote wake-up assembly is provided including a remote device containing logic adapted to: generate a pre-amble signal comprising a plurality of pre-determined signal pulses sequentially varied throughout a pre-amble period; and generate a main message signal after a wake-up time-period. A receiver system is included containing logic adapted to: poll for the signal pulses, the receiver system polling comprising an on-state having a on-state length sufficient for receiving at least two of the sequentially varied signal pulses; determine the wake-up time-period using said at least two of the signal pulses; place the receiver system into a low-power sleep state during the remaining portion of said wake-up time-period; reactivate the receiver system at the end of the wake-up time-period; and receive the main message.

### TECHNICAL FIELD

The present invention relates generally to a method for radio frequency wakeup sequencing and more particularly to a method for radio frequency wakeup with variable period to reduce Q-current draw.

### BACKGROUND OF THE INVENTION

A growing number of automotive electronic systems operate as a function of remote customer activation. These systems include portable transmitters carried by the operator and receiver systems positioned within the vehicle. Typically radio frequency receiver module must periodically poll radio frequency data to determine when an incoming signal is present. Every transmitter sends multiple frames of data such that the receiver's polling interval will detect some valid portion of the first frame and then stay awake to process the second frame.

This system, however, is inefficient. If a receiver incorrectly identifies noise as a valid wakeup, it may stay awake for along period waiting for the next frame of data from a transmitter. In addition, device battery life requirements usually determine the amount of quiescent current allowed for a radio frequency receiver. Quiescent current is the average current of the module over a period of time. The nature of existing receivers is that they often operate in an operating state equal to the amount of time they are in a sleep state. In addition, upon receipt of a frame signal, they typically remain on for extended periods. As such, their operating power when on must be kept low in order to comply with quiescent current guidelines.

If, however, a transmitter/receiver system could be designed that reduced the amount of time a receiver system actively polled, the current utilized by the receiver system during such reduced polling could be significantly increased. In addition, if a transmitter/receiver system could be designed with improved recognition of a messaging track, then the amount of time a receiver is active for false signaling could be drastically reduced.

### SUMMARY OF THE INVENTION

In accordance with the objects of the present invention a remote wake-up assembly is provided including a remote device containing logic adapted to: generate a pre-amble signal comprising a plurality of pre-determined signal pulses sequentially varied throughout a pre-amble period; and generate a main message signal after a wake-up time-period. A receiver system is included containing logic adapted to: poll for the signal pulses, the receiver system polling comprising an on-state having a on-state length sufficient for receiving at least two of the sequentially varied signal pulses; determine the wake-up time-period using said at least two of the signal pulses; place the receiver system into a low-power sleep state during the remaining portion of said wake-up time-period; reactivate the receiver system at the end of the wake-up time-period; and receive the main message.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of remote wake-up assembly in accordance with the present invention.

FIG. 2 is an illustration of the remote signal and receiver polling utilized by the remote wake-up assembly illustrated in FIG. 1.

### DESCRIPTION OF PREFERRED EMBODIMENTS

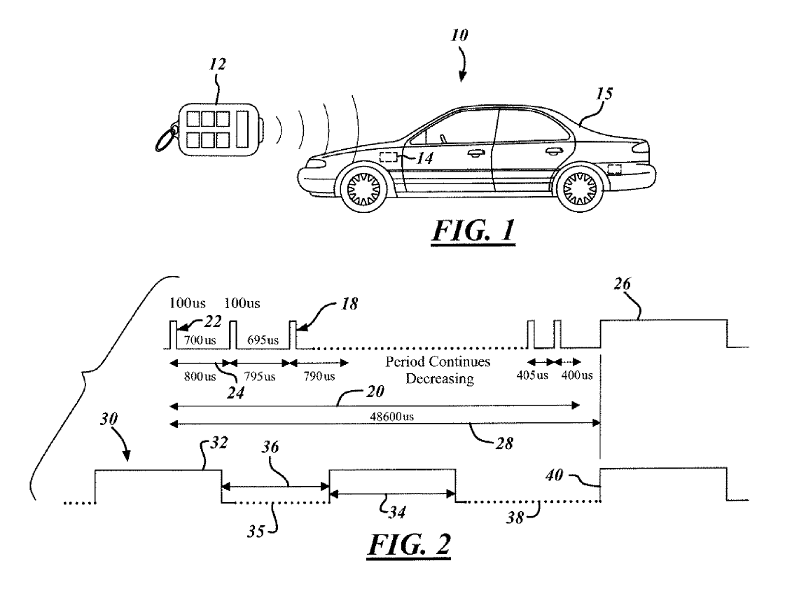

Referring now to FIG. 1, which is an illustration of a remote wake up assembly 10 in accordance with the present invention. The remote wake up assembly includes a portable remote device 12 for remote communication with a receiver system 14 positioned within a vehicle 15. The receiver system 14 is intended to encompass a wide variety of automotive systems such as, but not limited to, remote keyless entry systems, remote start systems, alarm functions, or other automotive systems intended to be remotely activated. The present invention utilized an optimized signal exchange that is optimized to minimize the quiescent current draw of the receiver system 14.

The present invention addresses this problem by endowing the remote device 12 with a logic adapted to generate a pre-amble signal 16. The pre-amble signal 16 is comprised of a plurality of signal pulses 18 sequentially varied in a predetermined fashion throughout a pre-amble period (length) 20. The predetermined variations allows the exact position in the pre-amble period 20 to be determined by receiving only two or more of the signal pulses 18. In one embodiment, the sequential variation comprises a countdown sequence. In this embodiment, the pulse width 22 of the signal pulses 18 remains the same while the pulse period 24 continually decreases in a predetermined manner. After the pre-amble period 20 is over, after a given time the remote device 12 generates a main message signal 26. The time period between the start of the pre-amble signal 16 and the main message signal 26 is the wake-up period 28.

The receiver system 14, in turn, contains logic to effect polls 30 for the signal pulses 18. The receiver system 14 logic comprises an on-state 32 having an on state length 34 sufficient to receive at least two of the signal pulses 18. The on-state length is preferably sufficient to receive at least three of the signal pulses 18. The on-state 32 poll is sequentially followed by of off-state 35 having an off-state length 36. The off-state length 36 is preferably shorter than the preamble period 20 to guarantee receipt of the preamble signal pulses 18. Due to the sequentially variable nature of the signal pulses 18, upon receipt of at least two of such pulses the receiver system 14 logic can calculate precisely where in the wake-up period 28 the remote deice 12 is. Upon such a determination, the logic places the receiver system 14 into a low power sleep state 38 until the end of the wake-up period 28. The receiver system 14 then reactivates 40 (re-enters an on-state 32) at the end of the wake-up period 28 to receive the main message signal 26. In this fashion the quiescent current draw of the receiver system 14 can be minimized. Furthermore, the on-state 32 current draw can be increased without violating quiescent current requirements.

Although a variety of pre-amble signals 16 and corresponding receiver polls 30 are contemplated, in one embodiment illustrated in FIG. 2, the pulse width 22 is approximately 100 microseconds followed by pulse periods 24 beginning at 800 microseconds and sequentially reducing by 5 microseconds until the main message signal 26. The preamble length 20 is preferably 48600 microseconds. The receiver polling 30 is preferably 3-5 milliseconds followed by a 40 millisecond off-state length 36. The off-state length 36 to on-state length 34 ratio is preferably greater than three to one. By keeping on to off lengths at less than 50% the quiescent current can be optimized such that it is kept below 1 milliamp. By increasing the preamble length 20, the off-state length 36 can be further maximized which may provide further minimization of the quiescent current draw.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A method of remotely activating an automotive system comprising:
generating a pre-amble signal using a remote device, said pre-amble signal comprising a plurality of signal pulses sequentially varied throughout a pre-amble period;
generating a main message signal after a wake-up time-period using said remote device;
polling for said signal pulses using a receiver system, said polling comprising an on-state of said receiver system having a on-state length sufficient for receiving at least two of said sequentially varied signal pulses;
determining said wake-up time-period using said at least two of said sequentially varied signal pulses;
placing said receiver system into a low-power sleep state during the remaining portion of said wake-up time-period; and
reactivating said receiver system at the end of said wake-up time-period; receiving said main message using said receiver system.

2. A method as described in claim 1, wherein said signal pulses comprise: a countdown sequence comprising a continuously diminishing pulse period.

3. A method as described in claim 1, wherein said on-state length is sufficient for receiving at least three of said signal pulses.

4. A method as described in claim 1, wherein said signal pulses comprise pulse on-widths of approximately 100 microseconds and pulse-off widths less than 1000 microseconds.

5. A method as described in claim 1, wherein preamble signal comprises a preamble length greater than 40,000 microseconds.

6. A method as described in claim 1, wherein said polling comprises an off-state length vs. on-state length ration greater than three to one.

7. A method as described in claim 1, wherein said polling comprises an off-state length of approximately 40 milliseconds and an on-state length of approximately 5 milliseconds.

8. A method as described in claim 1, wherein said receiver system draws less than 1 milliamp quiescent current during said wake-up time period.

9. A remote wake-up assembly comprising:
a remote device containing logic adapted to:
generate a pre-amble signal, said pre-amble signal comprising a plurality of pre-determined signal pulses sequentially varied throughout a pre-amble period; and
generate a main message signal after a wake-up time-period; and
a receiver system containing logic adapted to:
poll for said signal pulses, said receiver system polling comprising an on-state having a on-state length sufficient for receiving at least two of said sequentially varied signal pulses;
determine said wake-up time-period using said at least two of said sequentially varied signal pulses;
place said receiver system into a low-power sleep state during the remaining portion of said wake-up time-period;
reactivate said receiver system at the end of said wake-up time-period; and
receive said main message.

10. A remote wake-up assembly as described in claim 9, wherein said signal pulses comprise:
a countdown sequence comprising a continuously diminishing pulse period.

11. A remote wake-up assembly as described in claim 9, wherein said on-state length is sufficient for receiving at least three of said signal pulses.

12. A remote wake-up assembly as described in claim 9, wherein said signal pulses comprise pulse on-widths of approximately 100 microseconds and pulse-off widths less than 1000 microseconds.

13. A remote wake-up assembly as described in claim 9, wherein said preamble signal comprises a preamble length greater than 40,000 microseconds.

14. A remote wake-up assembly as described in claim 9, wherein said poll for said signal pulses comprises an off-state length vs. on-state length ration greater than three to one.

15. A remote wake-up assembly as described in claim 9, wherein said poll for said signal pulses comprises an off-state length of approximately 40 milliseconds and an on-state length of approximately 5 milliseconds.

16. A remote wake-up assembly as described in claim 9, wherein said receiver system draws less than 1 milliamp quiescent current during said wake-up time-period.

17. A remote wake-up assembly comprising:
a remote device containing logic adapted to:
generate a pre-amble signal, said pre-amble signal comprising a countdown sequence comprised of a plurality of pre-determined signal pulses throughout a pre-amble period; and
generate a main message signal after a wake-up time-period; and
a receiver system containing logic adapted to:
poll for said signal pulses, said receiver system polling comprising an on-state having a on-state length sufficient for receiving at least two of said signal pulses;
determine said wake-up time-period using said at least two of said signal pulses;
place said receiver system into a low-power sleep state during the remaining portion of said wake-up time-period;
reactivate said receiver system at the end of said wake-up time-period; and
receive said main message.

18. A remote wake-up assembly as described in claim 17, wherein said receiver system polling comprises an on-state length to off-state length of less than 50%.

19. A remote wake-up assembly as described in claim 17, wherein said signal pulses comprise pulse on-widths less than one quarter of pulse-off widths.

20. A remote wake-up assembly as described in claim 17, wherein said pre-amble period is increased such that a receiver data frame length may be maximized.
